(19) United States
(12) Patent Application Publication
(10) Pub. No.: US 2024/0027686 A1
(43) Pub. Date: Jan. 25, 2024

(54) OPTICAL ABSORBER AND OPTICAL ABSORPTION CHIP INTEGRATED WITH DIELECTRIC OPTICAL WAVEGUIDE

(71) Applicant: Silith Technology (Suzhou) Co., Ltd., Shanghai (CN)

(72) Inventor: Xingyu ZHANG, Shanghai (CN)

(73) Assignee: Silith Technology (Suzhou) Co., Ltd., Shanghai (CN)

(21) Appl. No.: 18/266,321

(22) PCT Filed: Feb. 25, 2022
(86) PCT No.: PCT/CN2022/078003

§ 371 Date: Jun. 9, 2023

(30) Foreign Application Priority Data
Aug. 26, 2021 (CN) 202110990948.6

(51) Int. Cl. G02B 6/126; G02B 6/134; G02B 5/00

(52) U.S. Cl. CPC G02B 6/126; G02B 6/1347; G02B 5/003

(57) ABSTRACT

The invention provides an optical absorber and an optical absorption chip integrated with a dielectric optical waveguide. The optical absorber comprises a waveguide cladding, a dielectric optical waveguide core and an absorption material layer, wherein the waveguide cladding surrounds the dielectric optical waveguide core and the absorption material layer, the dielectric optical waveguide core comprises a first end and a second end, a radial dimension of the dielectric optical waveguide core gradually decreases from the first end to the second end, a material of the absorption material layer can be metal or silicon, and the absorption material layer can be located on an upper layer of the dielectric optical waveguide core, or on a side of the dielectric optical waveguide core, or on a lower layer of the dielectric optical waveguide core, so that the optical absorber can reduce back-reflection and allow light to be completely absorbed.

### CROSS REFERENCE TO THE RELATED APPLICATIONS

This application is based upon and claims priority to Chinese Patent Application No. 2021109909486, Aug. 26, 2021, the entire contents of which are incorporated herein by reference.

### FIELD OF TECHNOLOGY

The invention relates to the field of integrated optical components and devices, and in particular to an optical absorber and an optical absorption chip integrated with a dielectric optical waveguide.

### BACKGROUND

Optical absorbers, also called optical terminators or sinks, are important components in integrated optical components and devices. They are used to eliminate unwanted light and to achieve low return loss (reflection). In the silicon-based integrated photonics technology, a silicon (Si) waveguide, as a semiconductor waveguide, can be formed into an optical absorber through doping by an ion implantation process, so that light can be eliminated by free carrier absorption. Besides the silicon waveguide, some dielectric optical waveguides (such as silicon dioxide, polymer, silicon nitride, aluminum nitride and other waveguides) are also widely used to the integrated photonics technology. Generally, the dielectric optical waveguide cannot be formed into an absorber by doping as the silicon waveguide. Therefore, at present, a simple method is to use a transition structure to transmit light from the dielectric optical waveguide to silicon, and then to use doped silicon as an absorber, but in this way, an additional transition structure has to be introduced, making the structure more complicated. At present, another method is to use absorption materials, such as germanium (Ge). Germanium on silicon is widely used for integrated photonics and can be used as a photodetector, but the yield of the integrated optical components and devices can be influenced by epitaxial growth of germanium, and the cost is further influenced. In addition, the interface of the dielectric optical waveguide and the germanium absorber can introduce some unwanted back-reflection. Therefore, there is an urgent need for novel optical absorbers for dielectric optical waveguides to improve the above problems.

### SUMMARY

The objective of the present invention is to provide an optical absorber and an optical absorption chip integrated with a waveguide, which are used to reduce back-reflection and make the light completely absorbed.

In a first aspect, the present invention provides an optical absorber integrated with a dielectric optical waveguide, wherein the optical absorber comprises a waveguide cladding, a dielectric optical waveguide core and an absorption material layer, the waveguide cladding is configured to surround the dielectric optical waveguide core and the absorption material layer, the dielectric optical waveguide core includes a first end and a second end, a radial dimension of the dielectric optical waveguide core gradually decreases from the first end to the second end, and the absorption material layer can be located on an upper layer of the waveguide, or located on a side of the waveguide, or located on a lower layer of the waveguide, so that the optical absorber can reduce back-reflection and allow light to be completely absorbed.

Optionally, a shape of the dielectric optical waveguide is a taper or a wedge. Because the tapered or wedge-shaped dielectric optical waveguide gradually increases the dimension of an optical mode, as a profile of the optical mode expands larger and larger, the evanescent tail of the optical mode starts to contact the absorption material layer above, and the absorption material layer introduces absorption, thus attenuating the optical power propagating along the waveguide. The gradient of an adiabatic mode is smooth enough to avoid abrupt transitions, thus the back-reflection can be significantly reduced.

Optionally, a width of the dielectric optical waveguide core changes gradually from one side to the other, and a material of the dielectric waveguide can be, but is not limited to, silicon dioxide, polymer, silicon nitride, aluminum nitride, etc.

Optionally, the dielectric optical waveguide core is arranged in a spiral or folded-loop shape in space, which is helpful to save the space on the optical integrated circuits, and the integration density of the optical integrated circuits is higher.

Optionally, a material of the absorption material layer is metal. Moreover, the optical absorber neither need to use ion implantation doping process nor introduce other materials such as germanium, so that its structure is easy to manufacture.

Optionally, a material of the absorption material layer is silicon that can be used to absorb light with a certain wavelength (such as visible light wavelength range).

Optionally, a PN junction or a PIN junction can be formed on the silicon by an ion implantation doping process. In this way, free carriers converted by absorption of light can be removed by applying reverse bias voltage.

In a second aspect, the present invention provides an optical absorption chip comprising a polarization rotator and the optical absorber as described in the first aspect, wherein the polarization rotator is used for rotating the input TE polarized light by 90 degrees to convert it into TM polarized light, and outputting the TM polarized light; and the optical absorber is used for absorbing TM polarized light. Because the absorption efficiency of the optical absorber is higher for TM polarized light, this structure can absorb light waves more effectively.

### BRIEF DESCRIPTION OF THE DRAWINGS

FIG. 1 is a perspective view of an optical absorber provided by the present invention;

FIG. 2 is a top view, a side view and a sectional view of an optical absorber provided by the present invention;

FIG. 3 is a perspective view of another optical absorber provided by the present invention;

FIGS. 4 to 6 are perspective views of another optical absorber provided by the present invention;

FIG. 7 is a top view of a spatial arrangement mode of a dielectric optical waveguide provided by the present invention;

FIG. 8 is a sectional view of intensity of a light mode provided by the present invention; and

FIG. 9 is a schematic diagram of an absorption mode of an optical absorption chip provided by the present invention.

### REFERENCE NUMERALS IN THE FIGURES

10. waveguide cladding;
20. dielectric optical waveguide core;
30. absorption material layer.

### DESCRIPTION OF THE EMBODIMENTS

In order to make the objectives, technical solutions and advantages of the present invention clearer, the technical solutions in the embodiments of the present invention will be described clearly and completely below in conjunction with accompanying drawings. Apparently, the embodiments described are some of embodiments of the present invention, but not all of the embodiments. All of the other embodiments, obtained by those of ordinary skill in the art based on the embodiments of the present invention without any inventive efforts, fall into the protection scope of the present invention. Unless defined otherwise, technical or scientific terms used herein have the same meaning as commonly understood by one of ordinary skill in the art to which this invention belongs. As used herein, “comprising”, “including” and the similar words mean that elements or articles appearing before the word encompass the elements or articles or equivalents thereof listed after the word, but do not exclude other elements of articles.

### Embodiment 1

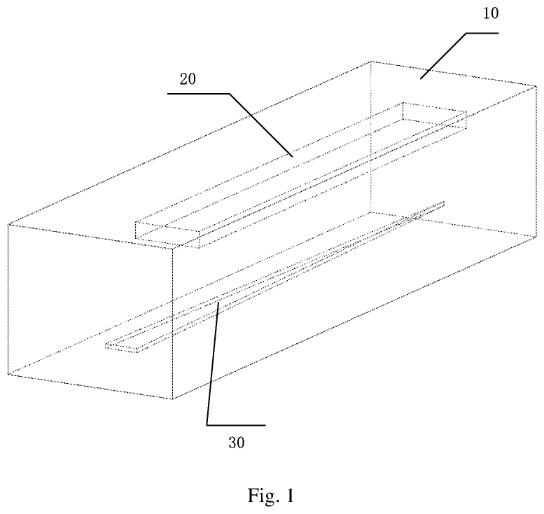

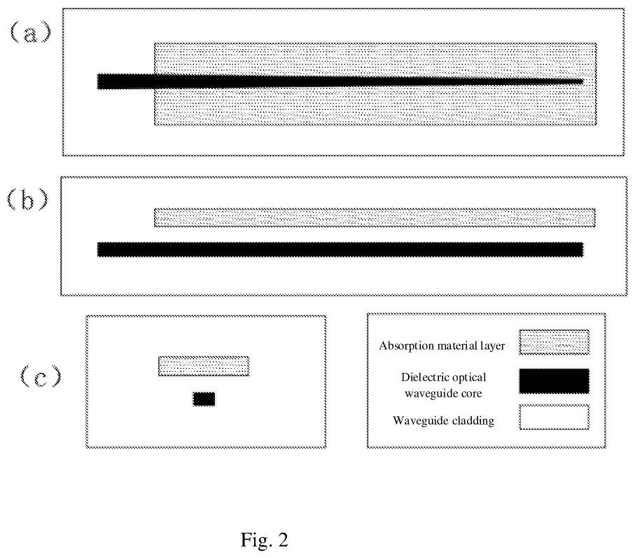

Aiming at the problems existing in the prior art, embodiment 1 of the present invention provides an optical absorber integrated with a dielectric optical waveguide, as shown in FIG. 1, including a waveguide cladding 10, a dielectric optical waveguide core 20 and an absorption material layer 30.

Where, the waveguide cladding 10 is configured to surround the dielectric optical waveguide core 20 and the absorption material layer 30; the dielectric waveguide core 20 includes a first end and a second end, and a radial dimension of the dielectric waveguide core 20 gradually decreases from the first end to the second end; and the absorption material layer 30 is located on an upper layer of the dielectric optical waveguide core. In addition, FIG. 2 is a top view, a side view and a sectional view of the optical absorber in FIG. 1, with the top view shown in FIG. 2(a), the side view shown in FIG. 2(b) and the sectional view shown in FIG. 2(c).

Exemplarily, a value range of the radial dimension of the first end is [500 nm, 2000 nm], and a value range of the radial dimension of the second end is [100 nm, 200 nm].

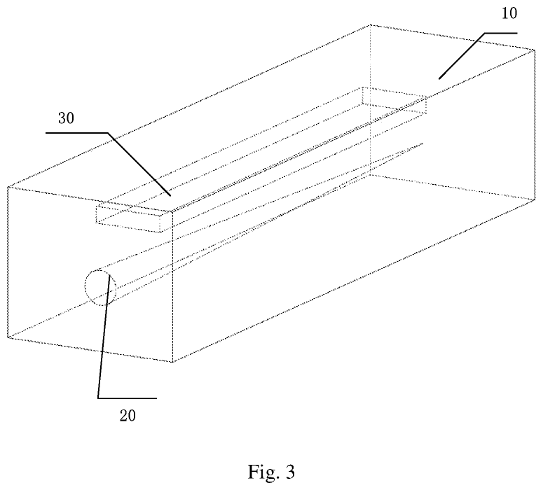

It is worth noting that FIG. 1 illustrates a wedge-shaped dielectric optical waveguide core 20, and it should be noted that the dielectric optical waveguide core 20 can also be tapered, as shown in FIG. 3.

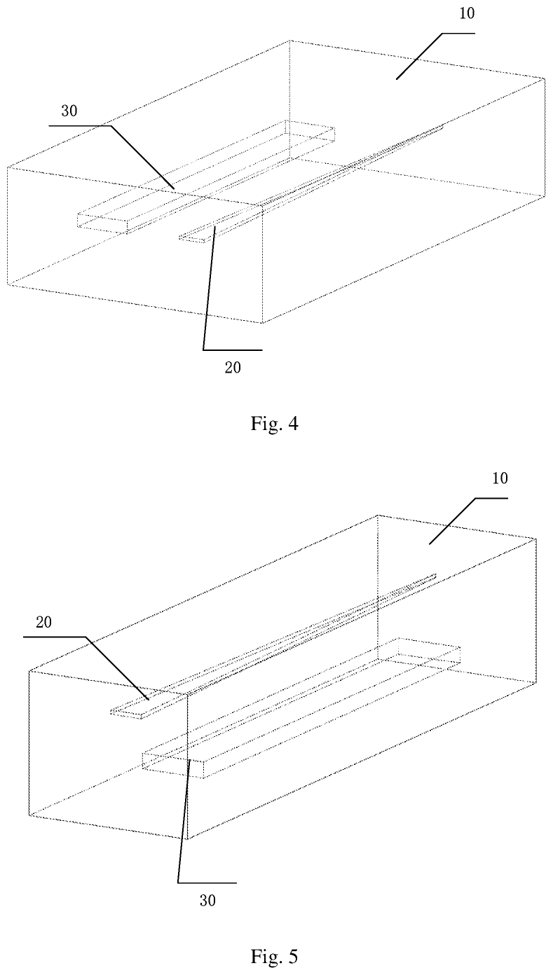

In another possible embodiment, as shown in FIG. 4, the absorption material layer 30 can also be located on one side of the dielectric optical waveguide core 20; or alternatively, as shown in FIG. 5, the absorption material layer 30 is located on a lower layer of the dielectric optical waveguide core 20; still alternatively, as shown in FIG. 6, the absorption material layers 30 can also be located on two sides of the dielectric optical waveguide core 20.

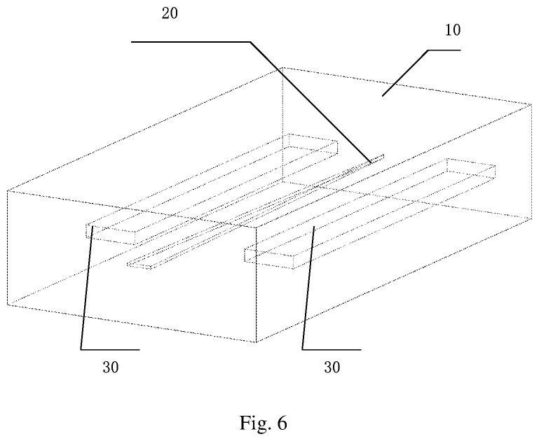

Optionally, the dielectric optical waveguide core 20 can be arranged in a spiral or folded-loop shape in space, with the top view of the spiral optical absorber shown in FIG. 7(a) and the top view of the folded-loop-shaped optical absorber shown in FIG. 7(b), and this arrangement helps to save the space in the optical integrated circuit components and devices, and the integration degree of the optical integrated circuit components and devices is higher.

Optionally, the absorption material layer 30 and the dielectric optical waveguide core 20 in the present invention can be provided by a standard integrated photonics foundry, so that their structures are compatible with a standard process flow. A material of the absorption material layer 30 can be metal, for example, but is not limited to aluminum, copper or tungsten. The optical absorber does not need to be implanted or and other materials such as germanium do not need to be introduced, so that the structure of the optical absorber is easy to manufacture. A material of the waveguide can be, but is not limited to, silicon dioxide, polymer, silicon nitride, aluminum nitride, etc.

Optionally, the absorption material layer 30 can also be a silicon layer, and the silicon layer can be used to absorb light of a certain wavelength (such as visible light band) and convert the light into free carriers. As shown in FIG. 2, a silicon layer is arranged on the lower layer of the dielectric optical waveguide core 20, and the silicon layer can absorb visible light propagating through the dielectric optical waveguide core 20, and can be top silicon on an SOI substrate.

Optionally, the silicon layer may be formed thereon with a PN junction or a PIN junction by an ion implantation doping process, so that free carriers converted by the absorption of light can be swept out by applying reverse bias voltage.

### Embodiment 2

Embodiment 2 is a solution based on embodiment 1, and its improvement lies in that the present invention further provides an optical absorption chip, which includes a polarization rotator and an optical absorber which is as described in embodiment 1. The polarization rotator is used for rotating the input transverse electric (TE) mode polarized light by 90 degrees to convert it into transverse magnetic (TM) mode polarized light, and outputting the TM polarized light. The optical absorber is used for absorbing the TM polarized light. Because the TM polarized light absorption efficiency of the optical absorber is higher, this structure can absorb light waves more effectively.

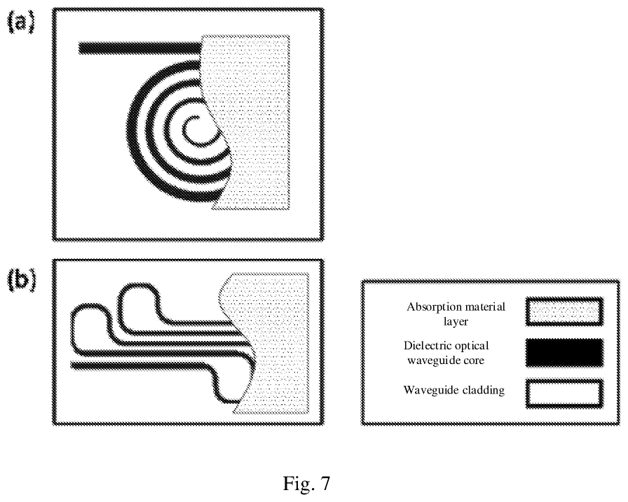

Simulated mode intensity profiles at narrow silicon nitride waveguide cross-sections for TE and TM polarizations are shown in FIG. 8(a) and FIG. 8(b), respectively; simulated mode intensity profiles after introduction of the absorption material layer over the waveguide are shown in FIG. 8(c) and FIG. 8(d), respectively; it can be seen that the absorption material layer interferes with the distribution of the optical mode, and according to experimental data, TM mode polarized light is lost more than TE mode polarized light, e.g., by a factor of 10, thus the TM mode polarized light absorption efficiency of the optical absorber is much better.

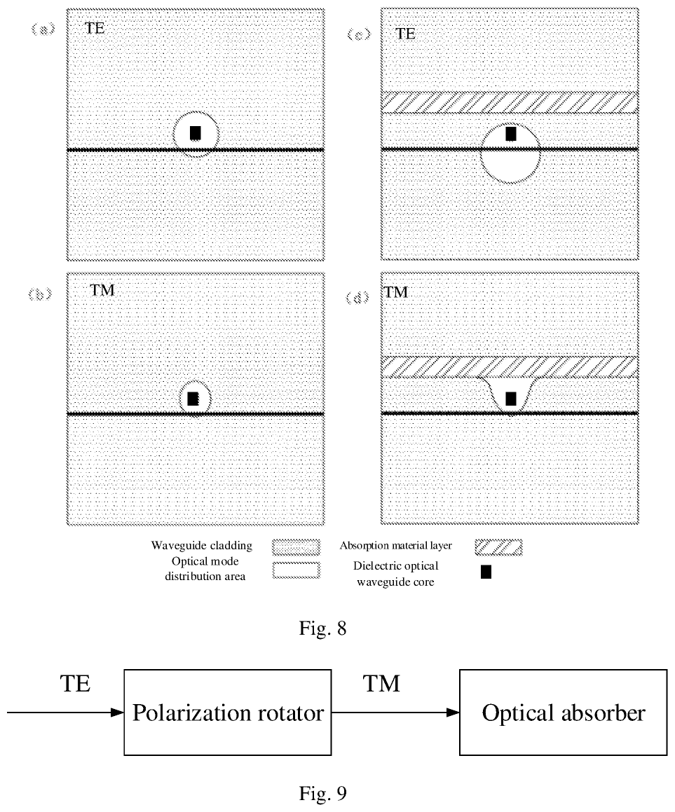

As shown in FIG. 9, based on the above optical absorption chip, the polarization of light waves is first converted from TE mode polarized light to TM mode polarized light, and then the optical absorber can absorb the TM mode polarized light more effectively.

It is worth noting that the above optical absorber and optical absorption chip can be applied to optical sensing, optical computing, optical communication, optical storage, optical radar and other scenes, and the present invention is not limited thereto.

Although the embodiments of the present invention have been described in detail above, it is apparent to those skilled in the art that various modifications and changes can be made to these embodiments. However, it is to be understood that such modifications and changes are within the scope and spirit of the present invention as stated in the claims. Moreover, the present invention described here can have other embodiments, and can be implemented or realized in various ways.

1. An optical absorber integrated with a dielectric optical waveguide, comprising:
a waveguide cladding configured to surround a dielectric optical waveguide core and an absorption material layer;
the dielectric optical waveguide core comprising a first end and a second end, a radial dimension of the dielectric optical waveguide core gradually decreasing from the first end to the second end; and
the absorption material layer located on an upper layer of the dielectric optical waveguide core, or located on a side of the dielectric optical waveguide core, or located on a lower layer of the dielectric optical waveguide core.

2. The optical absorber according to claim 1, wherein a shape of the dielectric optical waveguide is a taper or a wedge.

3. The optical absorber according to claim 1, wherein the dielectric optical waveguide is arranged in a spiral or folded-loop shape in space.

4. The optical absorber according to claim 1, wherein a material of the absorption material layer is metal.

5. The optical absorber according to claim 1, wherein a material of the absorption material layer is silicon.

6. The optical absorber according to claim 5, wherein the silicon is doped by an ion implantation process to form a PN junction or a PIN junction.

7. An optical absorption chip wherein the chip comprises a polarization rotator and the optical absorber in claim 1,
wherein the polarization rotator is configured for rotating input transverse electric (TE) mode polarized light by 90 degrees to convert it into transverse magnetic (TM) mode polarized light, and outputting the TM polarized light; and
the optical absorber is configured for absorbing the TM polarized light.
